(19) United States
(12) Patent Application Publication
(10) Pub. No.: US 2019/0153181 A1
(43) Pub. Date: May 23, 2019

(54) METHODS OF MANUFACTURING FOAMS COMPRISING NANOCELLULAR DOMAINS

(71) Applicant: Owens Corning Intellectual Capital, LLC, Toledo, OH (US)

(72) Inventor: Matthew Daniel Gawryla, Chagrin Falls, OH (US)

(21) Appl. No.: 15/759,537

(22) PCT Filed: Oct. 14, 2016
(86) PCT No.: PCT/US16/56936

§ 371 Date: Mar. 13, 2018

Related U.S. Application Data
(60) Provisional application No. 62/244,252, filed on Oct. 21, 2015.

(51) Int. Cl. C08J 9/00; B29C 48/00; B29C 44/20; B29C 44/34; B29C 44/50; C08J 9/12; C08J 9/14; C08L 25/06; C08L 25/12

(52) U.S. Cl. CPC C08J 9/0061; B29C 48/022; B29C 48/0012; B29C 44/20; B29C 44/3461; B29C 44/50; B29K 2025/06; C08J 9/146; C08J 9/142; C08J 9/125; C08L 25/06; C08L 25/12; C08J 9/122

(57) ABSTRACT

A composition and method for making polymeric foam comprising nanocellular domains is provided. The nanocellular domains in the polymeric foam increase the R-value of the polymeric foam product and improve thermal insulation performance. The polymeric foam having the nanocellular domains may be formed using a carbon dioxide-based blowing agent. The polymeric foam having the nanocellular domains can be produced on production-scale equipment in amounts suitable for large-scale applications.

### RELATED APPLICATIONS

This application claims priority to and all benefit of U.S. Provisional Patent Application Ser. No. 62/244,252, filed on Oct. 21, 2015, for METHODS OF MANUFACTURING FOAMS COMPRISING NANOCELLULAR DOMAINS, the entire disclosure of which is fully incorporated herein by reference.

### FIELD OF THE DISCLOSURE

The present disclosure relates to a composition and method for making polymeric foam.

### BACKGROUND

It is known that the overall heat transfer in a typical foam can be separated into three components: thermal conduction from gas (or blowing agent vapor), thermal conduction from polymer solids (including foam cell wall and strut), and thermal radiation across the foam [Schutz and Glicksman, J. Cellular Plastics, March-April, 114-121 (1984)]. Reducing the foam cell size to approximately the mean free path of gas molecules (typically, less than about 100 nm) results in the number of gas molecule collisions within the cell being significantly reduced and therefore thermal conduction from the gas being likewise significantly reduced. This is known as the Knudsen effect.

Foams comprising cell sizes of 1,000 nm or less (“nanocellular foams”) have been reported to have excellent insulating properties, due in part to the Knudsen effect. However, these foams have not been suitable for large-scale applications. Known nanocellular foams have often required expensive materials, such as aerogels. Known nanocellular foams have also been limited to small batch production due to scaling issues, which further drives up the cost. Therefore, known nanocellular foams have been limited to use in only a few niche applications. It has not been feasible to produce nanocellular foams on production-scale extruders in amounts suitable for large-scale applications, both for economic and manufacturing reasons.

### SUMMARY

Various exemplary embodiments of the present invention are directed to a composition and method for making polymeric foam. The composition and method for making polymeric foam disclosed herein include incorporating discrete regions, or “domains,” of a second polymer (the “domain polymer”) within a continuous matrix of a first polymer (the “matrix polymer”). The domain polymer is typically insoluble in the matrix polymer. When a foamable polymer mixture comprising the matrix polymer and the domain polymer is foamed, the matrix polymer forms a typical polymeric foam and the domain polymer forms separate domains of nanocellular foam (“nanocellular domains”) within the polymeric foam to achieve a foam having an improved thermal insulation performance.

In certain embodiments, the inventive concepts herein relate to a composition and method for making an extruded foam comprising nanocellular domains to achieve an extruded foam having an improved thermal insulation performance. In certain embodiments, the inventive concepts herein relate to a composition and method for making an extruded polystyrene (XPS) foam comprising nanocellular domains to achieve an XPS foam having an improved thermal insulation performance. In certain embodiments, the inventive concepts herein relate to a composition and method for making a bead-extruded foam comprising nanocellular domains to achieve a foam having an improved thermal insulation performance. In certain embodiments, the inventive concepts herein relate to a composition and method for making an expanded polymeric foam comprising nanocellular domains to achieve a foam having an improved thermal insulation performance. In some exemplary embodiments, the nanocellular domains comprise crosslinked polymers. In some exemplary embodiments, the nanocellular domains are formed from polymers with select melt properties. In some exemplary embodiments, the polymeric foam includes a carbon dioxide-based blowing agent.

In accordance with some exemplary embodiments, a foamable polymeric mixture is disclosed. The foamable polymer mixture comprises a matrix polymer, a domain polymer, and a blowing agent. The foamable polymeric mixture forms a polymeric foam comprising foamed nanocellular domains comprising the domain polymer, and the cells in the domain polymer have an average cell size of 1,000 nm or less.

In accordance with some exemplary embodiments, a method of manufacturing an extruded polymeric foam is disclosed. The method comprises introducing a composition comprising a matrix polymer into a screw extruder to form a matrix polymeric melt, introducing a domain polymer into the matrix polymeric melt, injecting a blowing agent into the matrix polymeric melt to form a foamable polymeric mixture, and extruding the foamable polymeric mixture to form an extruded polymeric foam. The extruded polymeric foam comprises foamed nanocellular domains comprising the domain polymer, and the cells in the domain polymer have an average cell size of 1,000 nm or less.

In accordance with some exemplary embodiments, an extruded polymeric foam is disclosed. The extruded polymeric foam comprises a foamable polymeric mixture comprising a matrix polymer, a domain polymer, and a blowing agent comprising carbon dioxide. The extruded polymeric foam comprises foamed nanocellular domains comprising the domain polymer, and the cells in the domain polymer have an average cell size of 1,000 nm or less.

### BRIEF DESCRIPTION OF THE DRAWINGS

Exemplary advantages of this invention will be apparent upon consideration of the following detailed disclosure of the invention, especially when taken in conjunction with the accompanying drawings wherein:

FIG. 1 is a schematic drawing of an exemplary extrusion apparatus useful for practicing methods according to the invention.

FIG. 2 is a cross-sectional schematic drawing illustrating the formation of a polymeric foam comprising nanocellular domains according to the invention.

### DETAILED DESCRIPTION OF THE DISCLOSURE

A composition and method for making polymeric foam are described in detail herein. The polymeric foam comprises nanocellular domains to achieve a polymeric foam having an improved thermal insulation performance. In certain embodiments, the inventive concepts herein relate to a composition and method for making an extruded foam comprising nanocellular domains to achieve an extruded foam having an improved thermal insulation performance. In certain embodiments, the inventive concepts herein relate to a composition and method for making an extruded polystyrene (XPS) foam comprising nanocellular domains to achieve an XPS foam having an improved thermal insulation performance. In certain embodiments, the inventive concepts herein relate to a composition and method for making a bead-extruded foam comprising nanocellular domains to achieve a foam having an improved thermal insulation performance. In certain embodiments, the inventive concepts herein relate to a composition and method for making an expanded polymeric foam comprising nanocellular domains to achieve a foam having an improved thermal insulation performance. In some exemplary embodiments, the nanocellular domains comprise crosslinked polymers. In some exemplary embodiments, the nanocellular domains are formed from polymers with select melt properties. In some exemplary embodiments, the polymeric foam includes a carbon dioxide-based blowing agent. These and other features of the polymeric foam, as well as some of the many optional variations and additions, are described in detail hereafter.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references. In the drawings, the thickness of the lines, layers, and regions may be exaggerated for clarity. It is to be noted that like numbers found throughout the figures denote like elements. The terms “composition” and “inventive composition” may be used interchangeably herein.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

As used herein, unless specified otherwise, the values of the constituents or components of the polymeric foam, the nanocellular domains in the polymeric foam or other compositions are expressed in weight percent or % by weight of each ingredient in the composition. The values provided include up to and including the endpoints given. Unless otherwise specified, the terms “% by weight” and “wt %” are used interchangeably and are meant to indicate a percentage based on 100% of the total weight of all ingredients excluding the weight or weight % of the blowing agent composition.

As it pertains to the present disclosure, “closed cell foam” generally refers to a polymeric foam having cells, at least 95% of which are closed. However, the present application also contemplates that cells may be “open cells” or closed cells (i.e., certain embodiments disclosed herein may exhibit an “open cell” polymeric foam structure).

As it pertains to the present disclosure, “matrix polymer” refers to the polymer which comprises the bulk or continuous phase of the polymeric foam. “Matrix polymer” may also refer to compositions comprising the matrix polymer and other components. As it pertains to the present disclosure, “domain polymer” refers to the polymer which comprises the nanocellular domains contained within the matrix polymer. “Domain polymer” may also refer to compositions comprising the domain polymer and other components.

The general inventive concepts herein relate to a composition and method for making a polymeric foam comprising nanocellular domains to achieve a polymeric foam having an improved thermal insulation performance. In some embodiments, the inventive concepts herein relate to a composition and method for making an extruded polymeric foam comprising nanocellular domains to achieve a polymeric foam having an improved thermal insulation performance. In some embodiments, the inventive concepts herein relate to a composition and method for making an XPS foam comprising nanocellular domains to achieve an XPS foam having an improved thermal insulation performance. In some embodiments, the inventive concepts herein relate to a composition and method for making a bead-extruded foam comprising nanocellular domains to achieve a foam having an improved thermal insulation performance. In some embodiments, the inventive concepts herein relate to a composition and method for making an expanded polymeric foam comprising nanocellular domains to achieve a foam having an improved thermal insulation performance.

A nanocellular domain comprises a domain polymer that is insoluble in the matrix polymer and remains in a distinctly separate domain as it is blended with the foamable polymeric mixture. When a suitable blowing agent is also added to the foamable polymeric mixture, and the foamable polymeric mixture exits the extrusion apparatus through the extrusion die, the foamable polymeric mixture undergoes foaming. The resulting foamed product comprises a continuous matrix of large cells formed from the matrix polymer and separate domains of nanocellular foams (i.e., “nanocellular domains”) formed from the domain polymer, where the nanocellular domains are distributed throughout the continuous matrix of the foamed product. In some exemplary embodiments, the nanocellular domains comprise crosslinked polystyrene. In some exemplary embodiments, the nanocellular domains are formed from polymers with select melt properties. In some exemplary embodiments, the extruded polymeric foam includes a carbon dioxide-based blowing agent.

### Methods of Manufacture

Polymeric foams containing nanocellular domain may be extruded foams or expanded foams. These polymeric foams may be made by modifying known manufacturing methods using typical manufacturing equipment.

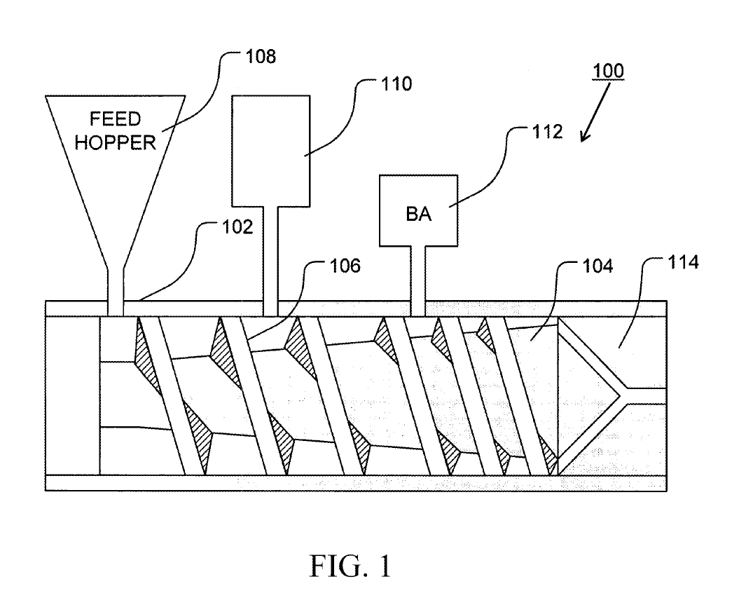

In some embodiments, the polymeric foams of the present disclosure are extruded polymeric foams made by an extrusion method. FIG. 1 illustrates a traditional extrusion apparatus 100 useful for practicing some exemplary embodiments of the present invention. The extrusion apparatus 100 may comprise a single or twin (not shown) screw extruder including a barrel 102 surrounding a screw 104 on which a spiral flight 106 is provided, configured to compress, and thereby, heat material introduced into the screw extruder. As illustrated in FIG. 1, the polymeric composition may be fed into the screw extruder as a flowable solid, such as beads, granules, or pellets, or as a liquid or semi-liquid melt, from one or more feed hoppers 108. The polymeric mixture introduced in feed hoppers 108 may comprise the matrix polymer, or the polymeric mixture introduced in feed hoppers 108 may comprise both the matrix polymer and the domain polymer, as described below.

As the initial polymeric mixture advances through the screw extruder, the decreasing spacing of the flight 106 defines a successively smaller space through which the polymeric mixture is forced by the rotation of the screw. This decreasing volume acts to increase the pressure of the polymeric mixture to obtain a polymeric melt (if solid starting material was used) and/or to increase the pressure of the polymeric melt.

As the polymeric mixture advances through the screw extruder 100, a port 110 configured for injecting one or more additives into the polymeric mixture may be provided through the barrel 102. In some embodiments, one or more domain polymers are introduced to the polymeric mixture through the port 110. Other exemplary additives such as a domain polymer, processing aids, nucleating agents, flame retardant agents, antioxidants, or stabilizers may also be introduced to the polymeric mixture through the port 110. Similarly, one or more additional ports 112 may be provided through the barrel 102 for injecting one or more blowing agents into the polymeric mixture. In some embodiments, a domain polymer and one or more optional processing aids and blowing agents are introduced through a single port (e.g., the port 110). In some embodiments, a one or more optional processing aids and blowing agents are introduced through a single port (e.g., the port 110). In some embodiments, nucleating agents and/or one or more optional processing aids and blowing agents are introduced through a single port (e.g., the port 110). In some embodiments, domain polymers, blowing agents, and other optional additives are introduced through a plurality of ports (e.g., the ports 110 and 112). Once these additives and blowing agents have been introduced into the polymeric mixture, the resulting mixture is subjected to some additional blending sufficient to distribute each of the additives generally uniformly throughout the polymeric mixture to obtain an extrusion composition.

This extrusion composition is then forced through an extrusion die 114, and exits the die into a region of reduced pressure (which may be below atmospheric pressure), thereby allowing the blowing agent to expand and produce a polymeric foam material. This pressure reduction may be obtained gradually as the extruded polymeric mixture advances through successively larger openings provided in the die or through some suitable apparatus (not shown) provided downstream of the extrusion die for controlling to some degree the manner in which the pressure applied to the polymeric mixture is reduced. The polymeric foam may be subjected to additional processing such as calendaring, water immersion, cooling sprays, or other operations to control the thickness and other properties of the resulting polymeric foam product.

In some embodiments, the polymeric foams of the present disclosure are extruded polymeric beads made by a bead extrusion method. Bead extrusion is similar to the extrusion process previously described. However, in bead extrusion, the extrusion die 114 contains a plurality of small holes such that the extrusion composition is extruded as beads. These beads are typically in the range of about 0.05 mm to about 2.0 mm in diameter. Furthermore, the extrusion composition is not allowed to foam once the beads containing the extrusion composition exit the extrusion die. Instead, the beads containing the extrusion composition are discharged into a coolant chamber or coolant bath, and the beads are rapidly cooled to below the glass transition temperature (T_{g}) of the extrusion composition. This rapid cooling prevents the extrusion composition in the beads from foaming.

In some embodiments of bead extrusion, the matrix polymer, domain polymer, blowing agents, and optional additives are introduced to the extruder as described above to form an extrusion composition. In some embodiment of bead extrusion, the matrix polymer, domain polymer, and optional additives are introduced to the extruder as described above to form an extrusion composition, but the blowing agent is added to the extruded beads via a pressure vessel after the beads have been extruded and cooled.

In some embodiments, the polymeric foams of the present disclosure are expanded polymeric foams made by an emulsion or suspension polymerization method. In some embodiments of expanded polymeric foams, the matrix polymer is polymerized from monomer dispersed in a liquid phase within a reaction vessel. Monomer of the domain polymer is also added to the liquid phase within the reaction vessel. In some embodiments, the monomers of the matrix polymer and the domain polymer are dispersed within the liquid phase within the reaction vessel at about the same time, and both polymerization reactions occur simultaneously. In some embodiments, the monomer of the matrix polymer is dispersed within the liquid phase within the reaction vessel and the polymerization reaction to form the matrix polymer occurs before the monomer of the domain polymer is dispersed within the liquid phase within the reaction vessel. Preferably, but not necessarily, the monomers of the matrix polymer and the domain polymer are immiscible with each other and with the liquid phase. In some embodiments, the size and concentration of the domain polymer regions within the matrix polymer are controlled by the ratio of matrix monomer to domain monomer added to the reaction vessel. In some embodiments, one or more blowing agents are added to the polymeric mixture by adding the blowing agent(s) as diluents within the liquid phase within the reaction vessel during one or both of the polymerization reactions. In some embodiments, one or more blowing agents are used as the liquid phase within the reaction vessel during one or both of the polymerization reactions. In some embodiments, one or more blowing agents are added to the polymeric mixture in a pressure vessel after the polymerization reactions have been completed.

### Matrix Polymer

The matrix polymer is the backbone of the formulation and provides strength, flexibility, toughness, and durability to the final product. The matrix polymer is not particularly limited, and generally, any polymer capable of being foamed may be used as the matrix polymer in the resin mixture. The matrix polymer may be thermoplastic or thermoset. The particular matrix polymer may be selected to provide sufficient mechanical strength and/or to be compatible with the process utilized to form final foamed polymer products. In addition, the matrix polymer is preferably chemically stable, that is, generally non-reactive, within the expected temperature range during formation and subsequent use in a polymeric foam.

As used herein, the term “polymer” is generic to the terms “homopolymer,” “copolymer,” “terpolymer,” and combinations of homopolymers, copolymers, and/or terpolymers. Non-limiting examples of suitable foamable matrix polymers include alkenyl aromatic polymers, polyvinyl chloride (“PVC”), chlorinated polyvinyl chloride (“CPVC”), polyethylene, polypropylene, polycarbonates, polyisocyanurates, polyetherimides, polyamides, polyesters, polycarbonates, polymethylmethacrylate, polyphenylene oxide, polyurethanes, phenolics, polyolefins, styrene acrylonitrile (“SAN”), acrylonitrile butadiene styrene (“ABS”), acrylic/styrene/acrylonitrile block terpolymer (“ASA”), polysulfone, polyurethane, polyphenylene sulfide, acetal resins, polyamides, polyaramides, polyimides, polyacrylic acid esters, copolymers of ethylene and propylene, copolymers of styrene and butadiene, copolymers of vinyl acetate and ethylene, rubber modified polymers, thermoplastic polymer blends, and combinations thereof.

In some embodiments, the matrix polymer is an alkenyl aromatic polymer material. Suitable alkenyl aromatic polymer materials include alkenyl aromatic homopolymers and copolymers of alkenyl aromatic compounds and copolymerizable ethylenically unsaturated co-monomers. In addition, the alkenyl aromatic polymer material may include minor proportions of non-alkenyl aromatic polymers. The alkenyl aromatic polymer material may be formed of one or more alkenyl aromatic homopolymers, one or more alkenyl aromatic copolymers, a blend of one or more of each of alkenyl aromatic homopolymers and copolymers, or blends thereof with a non-alkenyl aromatic polymer.

Examples of alkenyl aromatic polymers include, but are not limited to, those alkenyl aromatic polymers derived from alkenyl aromatic compounds such as styrene, styrene acrylonitrile (SAN) copolymers, alpha-methylstyrene, ethylstyrene, vinyl benzene, vinyl toluene, chlorostyrene, and bromostyrene. In some embodiments, the alkenyl aromatic polymer is polystyrene.

In some embodiments, minor amounts of monoethylenically unsaturated monomers such as C2 to C6 alkyl acids and esters, ionomeric derivatives, and C2 to C6 dienes may be copolymerized with alkenyl aromatic monomers to form the alkenyl aromatic polymer. Non-limiting examples of copolymerizable monomers include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate, and butadiene.

In some embodiments, the matrix polymer may be formed substantially of (e.g., greater than 95 percent), and in certain exemplary embodiments formed entirely of, polystyrene. The matrix polymer may be present in the polymeric foam in an amount from about 10% to about 95% by weight, in an amount from about 50% to about 95% by weight, or in an amount from about 75% to about 90% by weight. In some embodiments, the matrix polymer may be present in an amount from about 80% to about 90% by weight.

### Nanocellular Domains

The foamable polymeric mixture disclosed herein comprises at least one domain polymer that, upon foaming, will form separate nanocellular domains that are distributed within the matrix of the polymeric foam product. The nanocellular domains increase the R-value of the polymeric foam product.

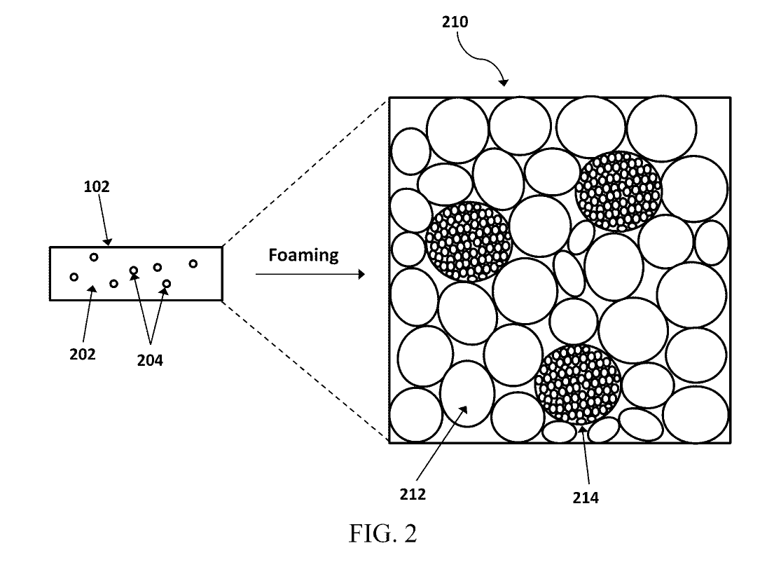

FIG. 2 is a cross-sectional view of the inventive extruded polymeric foam, illustrating the general principle of the present invention. Within the barrel 102 of an extrusion apparatus, a foamable polymeric mixture comprising a matrix polymer 202 and a domain polymer 204 is melted as previously described. The domain polymer 204 is insoluble in the matrix polymer 202. As the domain polymer 204 is blended with the matrix polymer 202, the domain polymer 204 remains in a plurality of distinctly separate domains that are dispersed and distributed within the matrix polymer 202 in the foamable polymeric mixture. A suitable blowing agent (not shown) is also added to the foamable polymeric mixture, as previously described. As the foamable polymeric mixture exits the extrusion apparatus through the extrusion die, the foamable polymeric mixture undergoes foaming. The resulting foamed product 210 comprises large cells 212 formed from the matrix polymer 202 and nanocellular domains 214 which are formed from the domain polymer 204.

The domain polymer may take various forms, and the nanocellular domains may be formed via a variety of mechanisms. The following exemplary foams comprising nanocellular domains and methods for producing them are intended to illustrate, but not limit, the inventive foam products.

### Crosslinked Domain Polymers

In some embodiments, the foamable polymeric mixture comprises at least one crosslinked domain polymeric mixture. In some embodiments, the crosslinked domain polymer is added to the molten matrix polymer in the extruder prior to the extrusion of the polymeric foam. In some embodiments, the crosslinked domain polymer may be added to the extrusion apparatus with the matrix polymer. In some embodiments, the crosslinked domain polymer may be included in a masterbatch with some or all of the matrix polymer, and the masterbatch is added to the extrusion apparatus. In some embodiments the crosslinked domain polymer may be added to the matrix polymer through a port in the extrusion apparatus.

The crosslinked domain polymer may be in particulate form. The crosslinked domain polymer is typically insoluble in the matrix polymer melt. Upon extrusion, the matrix polymer will foam to form foams of typical cell size, and the crosslinked domain polymer will also foam, but will form cells of nanocellular cell size due to the physical constraints of the crosslinked polymer structure. This process results in polymeric foam comprising nanocellular domains.

The crosslinked domain polymer may comprise any suitable crosslinkable polymer that is insoluble in the matrix polymer melt. The crosslinked domain polymer should be capable of dissolving the blowing agent used to create the foam. The crosslinked domain polymer should also be adequately crosslinked to create a nanocellular foam structure with appropriately-sized nanocells, such as individual nanocells from about 50 nm (0.05 μm) to about 1,000 nm (1 μm) in size. The particles of crosslinked domain polymer should be small enough not to block the extrusion apparatus or extrusion die, while being large enough to form effectively-sized nanocellular domains after foaming.

Suitable polymers for the crosslinked domain polymer include crosslinked alkenyl aromatic polymers, crosslinked polyolefins, and crosslinked polyacrylates. Exemplary polymers suitable as the crosslinked domain polymer include crosslinked polystyrene (PS), crosslinked polyethylene (PE), and crosslinked polymethylmethacrylate (PMMA).

The crosslinked domain polymer may be in particulate form. Particles of the crosslinked domain polymer should be in the range of about 5 μm to about 200 μm, including from 10 μm to about 200 μm, including from about 25 μm to about 175 μm, including about 50 μm to about 150 μm, and including about 75 μm to about 125 μm.

The crosslinked domain polymer should have an effective density of crosslinking for the present purpose. Too little crosslinking may result in the crosslinked domain polymer dissolving in the matrix polymer melt, or the creation during foaming of crosslinked domain polymeric foam cells that are too large. Too much crosslinking may reduce the solubility of the blowing agent within the crosslinked domain polymer particle to an unacceptable level, or make the crosslinked domain polymer particle too rigid to allow the formation of nanocellular foams. The range of effective densities of crosslinking will depend on the specific domain polymer used in the inventive polymer. Suitable crosslinking densities in the crosslinked domain polymer may range from about 0.5% to about 80%, including from about 1% to about 50%, from about 1% to about 5%, from about 5% to about 25%, and including from about 10% to about 20%.

The crosslinked domain polymer should be added to the matrix polymer at a concentration suitable for forming polymeric foam comprising nanocellular domains with the desired insulating properties. Suitable concentrations of crosslinked domain polymer may range from about 1 wt % to about 80 wt % of the total weight of the foamable polymeric mixture, excluding blowing agent. The concentration of crosslinked domain polymer may range from about 2 wt % to about 50 wt %, including from about 3 wt % to about 25 wt %, from about 4 wt % to about 20 wt %, from about 5 wt % to about 15 wt %, and including from about 7 wt % to about 10 wt % of the total weight of the foamable polymeric mixture.

Domain Polymers with Select Melt Properties

In some embodiments, polymeric foams comprising nanocellular domains may be formed by including domain polymers with certain defined melt properties in the foamable polymeric mixture. These domain polymers typically comprise polymers that are insoluble in the surrounding matrix polymer melt, and therefore the domain polymers form domains within the matrix of the polymer melt. For simplicity, domain polymers with certain defined melt properties are referred to as “high viscosity domain polymers,” although this designation does not imply and should not be interpreted as limiting the present invention to domain polymers where the viscosity of the domain polymer is the only or the primary melt property or feature of the domain polymer.

In some embodiments, the high viscosity domain polymer is added to the matrix polymer melt in the extruder prior to the extrusion of the polymeric foam. In some embodiments, the high viscosity domain polymer may be added to the extrusion apparatus with the matrix polymer. In some embodiments, the high viscosity domain polymer may be included in a masterbatch with some or all of the matrix polymer, and the masterbatch is added to the extrusion apparatus. In some embodiments, the high viscosity domain polymer may be added to the matrix polymer through a port in the extrusion apparatus.

The high viscosity domain polymer is typically insoluble in the matrix polymer melt. Within the extruder, the high viscosity domain polymer should preferably melt, soften, or otherwise become pliable at the temperature of the matrix polymer melt. The high viscosity domain polymer should preferably be blended substantially homogeneously as finely divided droplets or particles within the matrix polymer melt. The high viscosity domain polymer should be capable of dissolving the blowing agent used to create the foam. The finely divided droplets or particles of high viscosity domain polymer should be small enough not to block the extrusion apparatus or extrusion die, while being large enough to form effectively-sized nanocellular domains after foaming. For example, the finely-divided droplets or particles of high viscosity domain polymer in the matrix polymer melt may be in the range of about 5 μm to about 200 μm, including from 10 μm to about 175 μm, including about 25 μm to about 150 μm, including about 30 μm to about 125 μm, and including about 50 μm to about 100 μm.

In some embodiments, the high viscosity domain polymer should have melt properties that increases the likelihood of nanocellular domains being formed. In some embodiments, the high viscosity domain polymer is more likely to form nanocellular domains because the high viscosity domain polymer is higher viscosity than the surrounding matrix polymer. During foaming, the high viscosity domain polymer will restrict cell growth more than the matrix polymer, resulting in smaller cells in the domains comprising the high viscosity domain polymer.

In some embodiments, the high viscosity domain polymer may have a higher glass transition temperature (T_{g}) than the surrounding matrix polymer. During foaming, the high viscosity domain polymer with the higher T_{g} will solidify first (i.e., at a higher temperature) before the matrix polymer melt, which will freeze the foam cells within the high viscosity domain polymer domain at a smaller size than the cells of the matrix polymer.

In some embodiments, the high viscosity domain polymer has both a higher viscosity and a higher T_{g} than the surrounding matrix polymer. During foaming, the high viscosity domain polymer will restrict cell growth more than, and the cells in the high viscosity domain polymer domains will solidify before, the cells formed in the matrix polymer.

In some embodiments, the matrix polymer and high viscosity domain polymer have different chemistries (i.e., the monomer units making up the matrix polymer are not the same as the monomer units making up the domain polymer) as well as different viscosities. This difference in chemistry and viscosity results in the high viscosity domain polymer being insoluble in the matrix polymer melt, and therefore the domain polymers form domains within the matrix polymer as previously described.

In an exemplary embodiment wherein the matrix and high viscosity domain polymers have different chemistries and different viscosities, the matrix polymer is polystyrene (PS) and the high viscosity domain polymer is styrene-maleic anhydride copolymer (SMA). The PS has a lower T_{g} (e.g., about 100° C.) and a higher viscosity (e.g., an MFI greater than about 5 g/10 min at 200° C.), while the SMA has a higher T_{g} (e.g., about 150° C.) and a lower viscosity (e.g., an MFI of less than about 1 g/10 min at 200° C.). A blend of PS and SMA will form a mixture wherein the SMA forms distinct domains within the surrounding matrix of PS. When blowing agent is added to the PS/SMA polymer mixture, and the polymer mixture is foamed, the domains comprising SMA will form nanocellular domains and the PS will form the surrounding matrix polymeric foam. Similarly, in other embodiments, matrix and high viscosity domain polymers with different chemistries as well as different viscosity may be selected from polymers such as PVC, CPVC, SAN, PMMA, ABS, ASA, polyamides, polyesters, polycarbonates, polyurethanes, phenolics, etc., provided the viscosities and processing conditions are such that the higher viscosity domain polymer forms distinct domains within the matrix of the lower viscosity matrix polymer.

In other exemplary embodiments, the matrix polymer and high viscosity domain polymer have the same chemistry (i.e., the same monomer units make up the polymers), but the domain polymer has a higher viscosity than the matrix polymer. This difference in viscosity enables the high viscosity domain polymer to remain in distinct domains that are separate from the matrix polymer.

In an exemplary embodiment wherein the matrix and high viscosity domain polymers have the same chemistries but different viscosities, the matrix polymer is a low-density polyethylene (LDPE), and the high viscosity domain polymer is an ultra-high molecular weight polyethylene (UHMWPE). Molten LDPE typically has a moderate viscosity, such as a melt flow index (MFI) of about 10, whereas molten UHMWPE typically has a very high viscosity that cannot be measured under typical MFI test conditions. A blend of LDPE and UHMWPE will form a mixture wherein the UHMWPE forms distinct domains within the surrounding matrix of LDPE. When blowing agent is added to the LDPE/UHMWPE polymer mixture, and the polymer mixture is foamed, the domains comprising UHMWPE will form nanocellular domains and the LDPE will form the surrounding matrix polymeric foam. Similarly, in another exemplary embodiment, the matrix polymer is a low molecular weight polystyrene (LMWPS) with a moderate viscosity, and the high viscosity domain polymer is an ultra-high molecular weight polystyrene (UHMWPS). In yet other exemplary embodiments, matrix and high viscosity domain polymers with the same chemistry but different viscosity may be selected from polymers such as PVC, CPVC, SAN, PMMA, ABS, ASA, polyamides, polyesters, polycarbonates, polyurethanes, phenolics, etc., provided the viscosities and processing conditions are such that the higher viscosity polymer forms distinct domains within the matrix of the lower viscosity polymer.

The high viscosity domain polymer should be added to the matrix polymer melt at a concentration suitable for forming polymeric foam comprising nanocellular domains with the desired insulating properties. Suitable concentrations of high viscosity domain polymer may range from about 1 wt % to about 80 wt % of the total weight of the foamable polymeric mixture. The concentration of high viscosity domain polymer may range from about 2 wt % to about 50 wt %, including from about 3 wt % to about 25 wt %, from about 4 wt % to about 20 wt %, from about 5 wt % to about 15 wt %, and including from about 7 wt % to about 10 wt % of the total weight of the foamable polymeric mixture.

### Blowing Agents

Exemplary embodiments of the subject invention utilize a blowing agent composition. Any blowing agent may be used in accordance with the present invention. According to one aspect of the present invention, the blowing agent or co-blowing agents are selected based on the considerations of low global warming potential, low thermal conductivity, non-flammability, high solubility in the matrix polymer and domain polymer, high blowing power, low cost, and the overall safety of the blowing agent composition.

Due to environmental concerns about halogenated hydrocarbons, including halogenated blowing agents, non-halogenated blowing agents or co-blowing agents may be preferred. Halogenated blowing agents are also costly, so less costly blowing agents may be preferred. In some embodiments, the blowing agent or co-blowing agents comprise carbon dioxide. In some embodiments, carbon dioxide may comprise the sole blowing agent. In some embodiments, the blowing agent composition comprises carbon dioxide, along with one or more of a variety of co-blowing agents to achieve the desired polymeric foam properties in the final product. In some embodiments, the blowing agent composition comprises carbon dioxide and water. In some embodiments, the blowing agent composition comprises carbon dioxide and a hydrocarbon such as pentane. In some embodiments, the blowing agent composition comprises carbon dioxide and methanol. In some embodiments, the blowing agent composition comprises carbon dioxide and ethanol. However, in other embodiments, blowing agent compositions that do not include carbon dioxide may be used.

In some embodiments, the blowing agents or co-blowing agents of the blowing agent composition may comprise hydrocarbon gases and liquids. In some embodiments, the blowing agent or co-blowing agents of the blowing agent composition may comprise one or more halogenated blowing agents, such as hydrofluorocarbons (HFCs), hydrochlorofluorocarbons, hydrofluoroethers, hydrofluoroolefins (HFOs), hydrochlorofluoroolefins (HCFOs), hydrobromofluoroolefins, hydrofluoroketones, hydrochloroolefins, and fluoroiodocarbons. In some exemplary embodiments, the blowing agents or co-blowing agents of the blowing agent composition may comprise liquids, such as alkyl esters, such as methyl formate, water, alcohols such as ethanol, acetone, and mixtures thereof.

The hydrocarbon blowing agent or co-blowing agents may include, for example, propane, butanes, pentanes, hexanes, and heptanes. Preferred blowing agents or co-blowing agents include, but are not limited to, butanes, pentanes, heptanes, and combinations thereof. Butane blowing agents include, for example, n-butane and isobutane. Pentane blowing agents include, for example, n-pentane, isopentane, neopentane, and cyclopentane. Heptane blowing agents include, for example, n-heptane, isoheptane, 3-methylhexane, 2,2-dimethylpentane, 2,3-dimethylpentane, 2,4-dimethylpentane, 3,3-dimethylpentane, 3-ethylpentane, and 2,2,3-trimethylbutane.

The hydrofluoroolefin blowing agent or co-blowing agents may include, for example, 3,3,3-trifluoropropene (HFO-1243zf); 2,3,3-trifluoropropene; (cis and/or trans)-1,3,3,3-tetrafluoropropene (HFO-1234ze), particularly the trans isomer; 1,1,3,3-tetrafluoropropene; 2,3,3,3-tetrafluoropropene (HFO-1234yf); (cis and/or trans)-1,2,3,3,3-pentafluoropropene (HFO-1225ye); 1,1,3,3,3-pentafluoropropene (HFO-1225zc); 1,1,2,3,3-pentafluoropropene (HFO-1225yc); hexafluoropropene (HFO-1216); 2-fluoropropene, 1-fluoropropene; 1,1-difluoropropene; 3,3-difluoropropene; 4,4,4-trifluoro-1-butene; 2,4,4,4-tetrafluorobutene-1; 3,4,4,4-tetrafluoro-1-butene; octafluoro-2-pentene (HFO-1438); 1,1,3,3,3-pentafluoro-2-methyl-1-propene; octafluoro-1-butene; 2,3,3,4,4,4-hexafluoro-1-butene; 1,1,1,4,4,4-hexafluoro-2-butene (HFO-1336m/z); 1,2-difluoroethene (HFO-1132); 1,1,1,2,4,4,4-heptafluoro-2-butene; 3-fluoropropene, 2,3-difluoropropene; 1,1,3-trifluoropropene; 1,3,3-trifluoropropene; 1,1,2-trifluoropropene; 1-fluorobutene; 2-fluorobutene; 2-fluoro-2-butene; 1,1-difluoro-I-butene; 3,3-difluoro-I-butene; 3,4,4-trifluoro-I-butene; 2,3,3-trifluoro-1-butene; I, 1,3,3-tetrafluoro-I-butene; 1,4,4,4-tetrafluoro-1-butene; 3,3,4,4-tetrafluoro-1-butene; 4,4-difluoro-1-butene; I, I, 1-trifluoro-2-butene; 2,4,4,4-tetrafluoro-1-butene; 1,1,1,2-tetrafluoro-2 butene; 1,1,4,4,4-pentafluorol-butene; 2,3,3,4,4-pentafluoro-1-butene; 1,2,3,3,4,4,4-heptafluoro-1-butene; 1,1,2,3,4,4,4-heptafluoro-1-butene; and 1,3,3,3-tetrafluoro-2-(trifluoromethyl)-propene. In some exemplary embodiments, the blowing agent or co-blowing agents include HFO-1234ze.

The blowing agent or co-blowing agents may also include one or more hydrochlorofluoroolefins (HCFO), hydrochlorofluorocarbons (HCFCs), or hydrofluorocarbons (HFCs), such as HCFO-1233; 1-chloro-1,2,2,2-tetrafluoroethane (HCFC-124); 1,1-dichloro-1-fluoroethane (HCFC-141b); 1,1,1,2-tetrafluoroethane (HFC-134a); 1,1,2,2-tetrafluoroethane (HFC-134); 1-chloro 1,1-difluoroethane (HCFC-142b); 1,1,1,3,3-pentafluorobutane (HFC-365mfc); 1,1,1,2,3,3,3-heptafluoropropane (HFC-227ea); tnchlorofluoromethane (CFC-11); dichlorodifluoromethane (CFC-12); and dichlorofluoromethane (HCFC-22).

The term “HCFO-1233” is used herein to refer to all trifluoromonochloropropenes. Among the trifluoromonochloropropenes are included both cis- and trans-1,1,1-trifluoro-3-chloropropene (HCFO-1233zd or 1233zd). The term “HCFO-1233zd” or “1233zd” is used herein generically to refer to 1,1,1-trifluoro-3-chloropropene, independent of whether it is the cis- or trans-form. The terms “cis HCFO-1233zd” and “trans HCFO-1233zd” are used herein to describe the cis- and trans-forms of 1,1,1-trifluoro-3-chloropropene, respectively. The term “HCFO-1233zd” therefore includes within its scope cis HCFO-1233zd (also referred to as 1233zd(Z)), trans HCFO-1233zd (also referred to as 1233(E)), and all combinations and mixtures of these.

In some embodiments, the blowing agent or co-blowing agents may comprise one or more hydrofluorocarbons. The specific hydrofluorocarbon utilized is not particularly limited. A non-exhaustive list of examples of suitable HFC blowing agents or co-blowing agents include 1,1-difluoroethane (HFC-152a), 1,1,1,2-tetrafluoroethane (HFC-134a), 1,1,2,2-tetrafluoroethane (HFC-134), 1,1,1-trifluoroethane (HFC-143a), difluoromethane (HFC-32), 1,3,3,3-pentafluoropropane (HFO-1234ze), pentafluoro-ethane (HFC-125), fluoroethane (HFC-161), 1,1,2,2,3,3-hexafluoropropane (HFC 236ca), 1,1,1,2,3,3-hexafluoropropane (HFC-236ea), 1,1,1,3,3,3-hexafluoropropane (HFC-236fa), 1,1,1,2,2,3-hexafluoropropane (HFC-245ca), 1,1,2,3,3-pentafluoropropane (HFC-245ea), 1,1,1,2,3 pentafluoropropane (HFC-245eb), 1,1,1,3,3-pentafluoropropane (HFC-245fa), 1,1,1,4,4,4-hexafluorobutane (HFC-356mff), 1,1,1,3,3-pentafluorobutane (HFC-365mfc), and combinations thereof.

In some embodiments, the blowing agent or co-blowing agents are selected from hydrofluoroolefins, hydrofluorocarbons, and mixtures thereof. In some embodiments, the blowing agent composition comprises carbon dioxide and the co-blowing agent HFC-134a. In some embodiments, the blowing agent composition comprises carbon dioxide and HFO-1234ze. The co-blowing agents identified herein may be used singly or in combination.

In some embodiments, the total blowing agent composition is present in an amount from about 1% to about 15% by weight, and in some embodiments, from about 3% to about 10% by weight, or from about 3% to about 9% by weight (based upon the total weight of all ingredients excluding the blowing agent composition).

The blowing agent composition may be introduced in liquid or gaseous form (e.g., a physical blowing agent) or may be generated in situ while producing the foam (e.g., a chemical blowing agent). For instance, the blowing agent may be formed by decomposition of another constituent during production of the foamed thermoplastic. For example, a carbonate composition, polycarbonic acid, sodium bicarbonate, or azodicarbonamide and others that decompose and/or degrade to form N₂, CO₂, and H₂O upon heating may be added to the foamable resin and carbon dioxide will be generated upon heating during the extrusion process.

The foam composition may further contain a fire retarding agent in an amount up to 5% or more by weight (based upon the total weight of all ingredients excluding the blowing agent composition). For example, fire retardant chemicals may be added in the polymeric foam manufacturing process to impart fire retardant characteristics to the polymeric foam products. Non-limiting examples of suitable fire retardant chemicals for use in the inventive composition include brominated aliphatic compounds such as hexabromocyclododecane (HBCD) and pentabromocyclohexane, brominated phenyl ethers, esters of tetrabromophthalic acid, brominated polymeric flame retardants, phosphorous-based flame retardants, mineral-based flame retardants, and combinations thereof.

Optional additives such as nucleating agents, plasticizing agents, pigments, elastomers, extrusion aids, antioxidants, fillers, antistatic agents, biocides, termite-ocides, colorants, oils, waxes, flame retardant synergists, and/or UV absorbers may be incorporated into the inventive composition. These optional additives may be included in amounts necessary to obtain desired characteristics of the foamable gel or resultant polymeric foam products. The additives may be added to the polymer mixture or they may be incorporated in the polymer mixture before, during, or after the polymerization process used to make the polymer.

Once the polymer processing aid(s), blowing agent(s), and optional additional additives have been introduced into the polymeric material, the resulting mixture is subjected to some additional blending sufficient to distribute each of the additives generally uniformly throughout the polymeric mixture to obtain an extrusion composition.

In some exemplary embodiments, the foam composition produces rigid, substantially closed cell, polymeric foam boards prepared by an extruding process. Polymeric foams have a cellular structure with cells defined by cell membranes and struts. Struts are formed at the intersection of the cell membranes, with the cell membranes covering interconnecting cellular windows between the struts.

Nanocellular foams typically have higher densities than standard polymeric foams; however, because of the improved insulation values provided by the nanocellular domains to the polymeric foam as a whole, it is possible to reduce the density of the matrix polymer component of the foam and still maintain typical average foam densities and R values.

In some embodiments, the foams have an average density of less than 10 pcf, or less than 5 pcf, or less than 3 pcf. In some embodiments, the polymeric foam has a density from about 1 pcf to about 4.5 pcf. In some embodiments, the polymeric foam has a density from about 1.2 pcf to about 4 pcf. In some embodiments, the polymeric foam has a density from about 1.3 pcf to about 3.5 pcf. In some embodiments, the polymeric foam has a density from about 1.4 pcf to about 3 pcf. In some embodiments, the polymeric foam has a density from about 1.5 pcf to about 2.5 pcf. In some embodiments, the polymeric foam has a density from about 1.75 pcf to about 2.25 pcf. In some embodiments, the polymeric foam has a density of about 2 pcf. In some embodiments, the polymeric foam has a density of about 1.5 pcf, or lower than 1.5 pcf.

It is to be appreciated that the phrase “substantially closed cell” is meant to indicate that the foam contains all closed cells or nearly all of the cells in the cellular structure are closed. In some embodiments, not more than 30% of the cells are open cells, and particularly, not more than 10%, or more than 5% are open cells, or otherwise “non-closed” cells. In some embodiments, from about 1.10% to about 2.85% of the cells are open cells. The closed cell structure helps to increase the R-value of a formed, foamed insulation product. It is to be appreciated, however, that it is within the purview of the present invention to produce an open cell structure.

Additionally, the inventive foam composition produces polymeric foams that have insulation values (R-values) per inch of at least 4, or from about 4 to about 7. The average cell size of the matrix polymer cells in the inventive foam and foamed products may be from about 0.05 mm (50 μm) to about 0.4 mm (400 μm), in some embodiments from about 0.1 mm (100 μm) to about 0.3 mm (300 μm), and in some embodiments from about 0.11 mm (110 μm) to about 0.25 mm (250 μm). The average cell size of the domain polymer cells in the nanocellular domains in the inventive foam and foamed products may be from about 50 nm (0.05 μm) to about 1,000 nanometers (1 μm), in some embodiments from about 60 nm (0.06 μm) to about 800 nm (0.8 μm), in some embodiments from about 70 nm (0.07 μm) to about 600 nm (0.6 μm), in some embodiments from about 75 nm (0.075 μm) to about 500 nm (0.5 μm), in some embodiments from about 80 nm (0.08 μm) to about 250 nm (0.25 μm), and in some embodiments from about 90 nm (0.09 μm) to about 100 nm (0.1 μm). The inventive foam may be formed into an insulation product such as a rigid insulation board, insulation foam, packaging product, and building insulation or underground insulation (for example, highway, airport runway, railway, and underground utility insulation).

The inventive foamable polymeric mixture additionally may produce polymeric foams that have a high compressive strength, which defines the capacity of a foam material to withstand axially directed pushing forces. In some embodiments, the inventive foam compositions have a compressive strength within the desired range for polymeric foams, which is between about 6 psi and 120 psi. In some embodiments, the inventive foamable polymeric mixture produces foam having a compressive strength between about 10 psi and about 110 psi after 30 days aging.

The inventive foamable polymeric mixture additionally may produce polymeric foams that have a high level of dimensional stability. For example, the change in dimension in any direction is 5% or less. As used herein, the average cell size is an average of the cell sizes as determined in the X, Y, and Z directions. In particular, the “X” direction is the direction of extrusion, the “Y” direction is the cross machine direction, and the “Z” direction is the thickness. In the present invention, the highest impact in cell enlargement is in the X and Y directions, which is desirable from an orientation and R-value perspective. In addition, further process modifications would permit increasing the Z-orientation to improve mechanical properties while still achieving an acceptable thermal property. The inventive polymeric foam can be used to make insulation products such as rigid insulation boards, insulation foam, and packaging products.

As previously disclosed in detail herein, polymeric foam comprising nanocellular domains has an improved thermal insulation performance. In some embodiments, the nanocellular domains comprise about 1% to about 80% of the total volume of the polymeric foam. In some embodiments, the nanocellular domains comprise about 2% to about 50%, including from about 3% to about 25%, from about 4% to about 20%, from about 5% to about 15%, and including from about 7% to about 10%, of the total volume of the polymeric foam. In some embodiments, by utilizing carbon dioxide as a blowing agent, the polymeric foam comprising nanocellular domains have insulating properties approaching or exceeding the insulating properties of polymeric foams using thermal blowing agents, at reduced cost.

As used in the description of the invention and the appended claims, the singular forms “a,” “an,” and “the” are intended to include the plural forms as well, unless the context clearly indicates otherwise. To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

Unless otherwise indicated herein, all sub-embodiments and optional embodiments are respective sub-embodiments and optional embodiments to all embodiments described herein. While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative process, and illustrative examples shown and described. Accordingly, departures may be made from such details without departing from the spirit or scope of the applicant's general disclosure herein.

What is claimed is:

1. A foamable polymeric mixture comprising:
a matrix polymer;
a domain polymer; and
a blowing agent;
wherein the foamable polymeric mixture is formed into a polymeric foam comprising foamed nanocellular domains comprising domain polymer cells with an average cell size of 1,000 nm or less.

2. The foamable polymeric mixture of claim 1, wherein the domain polymer cells have an average cell size of 100 nm or less.

3. The foamable polymeric mixture of claim 1, wherein the blowing agent comprises carbon dioxide.

4. The foamable polymeric mixture of claim 1, wherein the blowing agent further comprises at least one co-blowing agent.

5. The foamable polymeric mixture of claim 4, wherein the at least one co-blowing agent is selected from hydrofluoroolefins, hydrofluorocarbons, alcohols, water, and mixtures thereof.

6. The foamable polymeric mixture of claim 1, wherein the domain polymer comprises from about 1% to about 80% by weight of the foamable polymer mixture.

7. The foamable polymer mixture of claim 1, wherein the matrix polymer comprises at least one of polystyrene and styrene acrylonitrile copolymer.

8. The foamable polymer mixture of claim 1, wherein the domain polymer is selected from the group consisting of crosslinked polystyrene, crosslinked polyethylene, crosslinked polyacrylate, crosslinked polymethylmethacrylate, high-viscosity polystyrene, ultra-high molecular weight polyethylene, high-viscosity polymethylmethacrylate, and combinations thereof.

9. A method of manufacturing extruded polymeric foam, the method comprising:
introducing a composition comprising a matrix polymer into a screw extruder to form a matrix polymeric melt;
introducing a domain polymer into the matrix polymeric melt;
injecting a blowing agent into the matrix polymeric melt to form a foamable polymeric mixture; and
extruding the foamable polymeric mixture to form an extruded polymeric foam,
wherein the extruded polymeric foam comprises foamed nanocellular domains comprising domain polymer cells with an average cell size of 1,000 nm or less.

10. The method of claim 9, wherein the domain polymer cells have an average cell size of 100 nm or less.

11. The method of claim 9, wherein the blowing agent comprises carbon dioxide.

12. The method of claim 11, wherein the blowing agent further comprises at least one co-blowing agent.

13. The method of claim 12, wherein the at least one co-blowing agent is selected from hydrofluoroolefins, hydrofluorocarbons, alcohols, water, and mixtures thereof.

14. The method of claim 9, wherein the domain polymer comprises from about 1% to about 80% by weight of the foamable polymeric mixture.

15. The method of claim 9, wherein the matrix polymer comprises polystyrene or styrene acrylonitrile copolymer.

16. The method of claim 9, wherein the domain polymer is selected from the group consisting of crosslinked polystyrene, crosslinked polyethylene, crosslinked polyacrylate, crosslinked polymethylmethacrylate, high-viscosity polystyrene, ultra-high molecular weight polyethylene, high-viscosity polymethylmethacrylate, and combinations thereof.

17. An extruded polymeric foam comprising:
a foamable polymeric mixture, the mixture comprising:
a matrix polymer;
a domain polymer; and
a blowing agent comprising carbon dioxide,
wherein the extruded polymeric foam comprises foamed nanocellular domains comprising domain polymer cells with an average cell size of 1,000 nm or less.

18. The extruded polymeric foam of claim 17, wherein the matrix polymer comprises polystyrene or styrene acrylonitrile copolymer.

19. The extruded polymeric foam of claim 17, wherein the domain polymer is selected from the group consisting of crosslinked polystyrene, crosslinked polyethylene, crosslinked polyacrylate, crosslinked polymethylmethacrylate, high-viscosity polystyrene, ultra-high molecular weight polyethylene, high-viscosity polymethylmethacrylate, and combinations thereof.

20. The extruded polymeric foam of claim 17, wherein the foamed nanocellular domains comprise from about 1% to about 80% by volume of the extruded polymeric foam.
